(19) United States
(12) Patent Application Publication
(10) Pub. No.: US 2008/0286646 A1
(43) Pub. Date: Nov. 20, 2008

(54) Electrolytes for Lithium Ion Batteries and Their Fabrication Methods

(75) Inventors: Feng Xiao, Shenzhen (CN); Mingxia Wang, Shenzhen (CN); Guishu Zhou, Shenzhen (CN); Huaying You, Shenzhen (CN)

Correspondence Address: VOLPE AND KOENIG, P.C., UNITED PLAZA, SUITE 1600, 30 SOUTH 17TH STREET, PHILADELPHIA, PA, 19103, US

(73) Assignee: BYD COMPANY LIMITED, Longgang, Shenzhen (CN)

(21) Appl. No.: 12/093,397

(22) PCT Filed: Nov. 23, 2006
(86) PCT No.: PCT/CN2006/003152

§ 371 Date: Jul. 2, 2008

(30) Foreign Application Priority Data
Nov. 24, 2005 (CN) 200510123943.4

(51) Int. Cl. H01M 10/26; H01M 10/24; H01M 2/14; H01M 10/28

(52) U.S. Cl. 429/129; 29/623.2; 429/200

(57) ABSTRACT

Electrolytes for lithium ion batteries are provided. The electrolytes include lithium salts, organic solvents and additives. In particular, the additives include halogeno-benzene and/or its homologs, the S═O bond compounds, biphenyl and/or its homologs, phenylcyclohexane and/or its homologs, teraklylbenzenes, and di-cycladipate and/or its homologs. Lithium ion batteries using said electrolytes exhibit improved overcharging safety properties, high temperature storage stability properties and cycle life properties simultaneously.

### CROSS REFERENCE

This application claims priority from a Chinese patent application entitled “Electrolytes, Lithium Ion Batteries with the Electrolytes and Their Fabrication Methods” filed on Nov. 24, 2005, having a Chinese Application No. 200510123943.4. This Chinese application is incorporated herein by reference.

### FIELD OF INVENTION

This invention relates to electrolytes for lithium ion batteries and their fabrication methods, and in particular, non-aqueous electrolytes of lithium ion batteries and their fabrication methods.

### BACKGROUND

Lithium ion rechargeable batteries are a relative new chemical energy source. They have been widely used in portable electronic equipment because of the high energy density, high operating voltage, long usage life and environmental friendliness.

A lithium ion rechargeable battery includes a positive electrode, a negative electrode, a separation membrane and an electrolyte. The electrolyte includes a lithium salt, an organic solvent and an additive. With the increasing uses of the lithium ion rechargeable batteries, there are increasing demands for better properties of the lithium ion rechargeable batteries in the marketplace. For example, existing technologies can improve certain properties of the lithium ion rechargeable batteries, such as overcharging safety properties, high-temperature storage stability properties and cycling life properties, by adding certain additives.

Patent CA2205683 disclosed that addition of biphenyl in the electrolyte could improve a battery's anti-overcharging properties. When the lithium ion battery is overcharged, the biphenyl monomers form conductive polymers. The conductive polymers cause the lithium ion battery to short circuit and release the excess electricity in case of overcharging. As a result, the lithium ion battery is prevented from explosion due to overheating.

U.S. Pat. No. 6,632,572 disclosed that addition of additive such as cyclalkylbenzene to the electrolyte improves the battery's anti-overcharging properties. When the lithium ion battery is overcharged, the battery releases H₂ that activates the electrical current termination apparatus of the battery. As a result, the lithium ion battery has better anti-overcharging properties with said additive.

Patent 2004259002 disclosed that addition of O═S═O bond compounds to the electrolyte improves the battery's high temperature storage stability properties. The O═S═O bond compounds form conductive polymerization membranes after being added to the electrolyte and the membranes inhibit the electrolyte from releasing gas generated from the decomposition of electrolyte when the battery is overcharged. As a result, the battery is prevented from volume expansion when being stored at high temperatures. Therefore, the battery has improved high temperature storage stability properties with said additive.

Although the additives mentioned above can enhance certain properties of the lithium ion batteries, such as overcharging safety properties, high temperature storage stability properties and cycling life properties, the additives could affect other properties negatively. For example, the electrolyte with phenylcyclohexane as additive would substantially improve the battery's overcharging safety properties, however, the additive would cause battery volume expansion and shorten battery cycling life.

Due to the limitations of the prior art, it is therefore desirable to have novel electrolytes that can improve the lithium ion rechargeable battery's overcharging safety properties, high temperature storage stability properties and cycling life properties simultaneously.

### SUMMARY OF INVENTION

An object of this invention is to provide electrolytes that effectively improve the overcharging safety properties, high-temperature storage stability properties and cycling life properties of the lithium ion batteries simultaneously.

Another object of this invention is to provide methods of fabrication for said electrolytes.

Another object of this invention is to provide new lithium ion batteries.

Another object of this invention is to provide methods of fabrication for said lithium ion batteries.

Briefly, the present invention relates to new compositions for electrolytes of lithium ion batteries. Said electrolytes are comprised of lithium salts, organic solvents and additives. In particular, the additives are comprised of halogeno-benzene and/or its homologs, the S═O bond compounds, biphenyl and/or its homologs, phenylcyclohexane and/or its homologs, teraklylbenzenes, and di-cycladipate and/or its homologs.

An advantage of this invention is that lithium ion batteries having electrolytes with said additives that are embodiments of this invention have improved overcharging safety properties, high temperature storage stability properties and cycling life properties simultaneously.

### DESCRIPTION OF DRAWINGS

The foregoing and other objects, aspects and advantages of the invention will be better understood from the following detailed description of the preferred embodiments of this invention when taken in conjunction with the accompanying drawings in which:

FIG. 1 is a diagram showing a perspective view of a lithium ion rechargeable battery.

FIG. 2 is a diagram showing the relationship between the capacity residual rate and cycling time.

### DETAILED DESCRIPTION OF THE PREFERRED EMBODIMENTS

In the presently preferred embodiments of electrolytes for lithium ion rechargeable batteries of the present invention may be comprised of lithium salts, organic solvents and additives. In particular, the additives are comprised of halogeno-benzene and/or its homologs, the S═O bond compounds, biphenyl and/or its homologs, phenylcyclohexane and/or its homologs, teraklylbenzenes, and di-cycladipate and/or its homologs.

In the embodiments of said electrolytes for lithium ion rechargeable batteries of the present invention, the weight of said additive is 2 wt % to 25 wt % of the weight of said electrolyte. Moreover, in the preferred embodiments of said electrolytes, the weight of said additive is from 10 wt % to 15 wt % of the weight of the electrolyte. In particular, the weight of the ingredients in the additive as a weight percentage of the weight of the additive is: halogeno-benzene and/or its homologs (0.3 wt %-95 wt %, preferably 5 wt %-30 wt %), S═O bond compound (0.1 wt %-95 wt %, preferably 12 wt %-37 wt %), biphenyl and/or its homologs (0.1 wt %-94 wt %, preferably 3 wt %-28 wt %), phenylcyclohexane and/or its homologs (0.3 wt %-95 wt %, preferably 6 wt %-36 wt %), teraklylbenzenes (0.3 wt %-96 wt %, preferably 5 wt %-40 wt %), di-cycladipate and/or its homologs (0.1 wt %-94 wt %, preferably 7 wt %-30 wt %).

Said halogeno-benzene and/or its homologs can be any halogeno-benzene and/or its homolog with a phenyl that at least one of the hydrogen on said phenyl is replaced by either a halogen substituting group or a halogenating alkyl substituting group. As shown in formula (I), at least one of the R₁-R₆ is substituted by either a halogen group or a halogenating alkyl group, preferably by at least one from the following: fluorobenzene, chlorobenzene and bromobenzene.

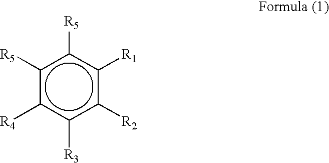

Said S═O bond compounds can be sulfinyl organic compounds or sulfonic organic compounds, preferably at least one from the following: ethylene sulfite, propylene sulfite, 1,3-propane sultone, dimethyl sulfite, diethyl sulfite, dimethyl sulfoxide.

Said biphenyl and/or its homologs can be organic compounds as shown in Formula 2. In particular, some or all of the R₁-R₅ and R′₁-R′₅ can be substituted by identical or different alkyl, preferably the alkyl can be selected from at least one of the following: biphenyl, 3-cyclohexyl biphenyl, trebiphenyl, 1,3-biphenyl cyclohexane.

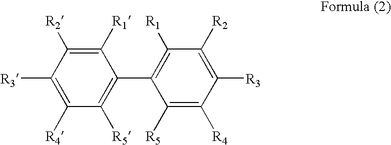

Said phenylcyclohexane and/or its homologs can be organic compounds as shown in Formula 3. In particular, some or all of the R₁-R₆ and R′₁-R′₅ can be substituted by identical or different alkyl, preferably said alkyl can be selected from at least one of the following: 1,3-dicyclohexylbenzene and phenylcyclohexane.

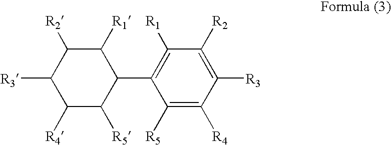

Said teraklylbenzene can be organic compounds as shown in Formula 4. In particular, some or all of the R₁, R₂ and R′₁-R′₅ can be substituted by identical or different alkyl. R₃ can be 1-10 methylene, preferably at least one of the following: tert-butyl benzene, tert-amylbenzene, tert-hexyl benzene.

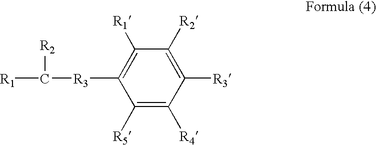

Said di-cycladipate and its homologs can be selected from at least one of the following: succinic anhydride, dimethyl adipate, hexane dioic anhydride and their alkyl substitution compounds, preferably succinic anhydride.

All the chemicals used as additives could either be purchased from the market or be synthesized using existing methods. Unless specially disclosed here, all the chemicals used as additives for the embodiments of this invention are analytical grade in the market.

The embodiments of said electrolytes contain lithium salts that are currently used in lithium ion secondary batteries. These lithium salts include, but are not limited to, one or more of the following: lithium hexafluorophosphate (LiPF₆), tetrafluoroboric acid lithium (LiBF₄), hexafluoro arsenic lithium (LiSbF₆), lithium perchlorate trihydrate (LiClO₄), fluorine alkyl sulfonic lithium (LiCF₃SO₃), Li(CF₃SO₂)₂N, LiC₄F₉SO₃, chlorine aluminic acid lithium (LiAlCl₄), LiN(CₓF₂ₓ₊₁SO₂)(C_{y}F_{2y+1}SO₂) (x and y are numbers from 1 to 10), lithium chloride (LiCl) and lithium iodide (LiI). The concentration of lithium salt in the electrolyte solute is normally 0.1 mol/L to 2.0 mol/L. In preferred embodiments, the concentration of lithium salt is 0.7 mol/L to 1.6 mol/L.

Said organic solvents can be various high boiling point solvents, low boiling point solvents or their mixtures. For example, the organic solvent can be selected at least one from the following: γ-butyrolactone, ethylene carbonate, ethyl methyl carbonate, dimethyl carbonate, diethyl carbonate, methyl propyl carbonate, dipropyl carbonate, propylene carbonate, vinylene carbonate, sultone, orbicular organic ester containing fluorine, sulfur or unsaturated bond, organic acid anhydride, N-methyl-2-pyrrolidone, N-methyl formamide, N-methyl acetamide, acetonitrile, N,N-dimethyl formamide, tetramethylene sulfone and dimethyl sulfoxide. The embodiments of said organic solvents can be mixtures of any two, three or four said solvents, preferably at a volume ratio of 1: (0.2-4) or 1: (0.2-4):(0.1-3) or 1:(0.3-2.5):(0.2-4):(0.1-4) respectively. In said mixed organic solvents, the concentration of lithium salt is 0.1 mol/L to 2.0 mol/L, preferably 0.7 mol/L to 1.6 mol/L.

The methods of fabricating the embodiments of electrolyte for lithium ion rechargeable batteries include mixing a lithium salts, an organic solvent and an additive together. In particular, the additive is comprised of halogeno-benzene and/or its homologs, the S═O bond compounds, biphenyl and/or its homologs, phenylcyclohexane and/or its homologs, teraklylbenzenes, and di-cycladipate and/or its homologs. 2 wt % to 25 wt % of the total weight of the electrolyte of said additive is added into the electrolyte. Moreover, in the preferred embodiments of said electrolyte, 10 wt % to 15 wt % of the total weight of the electrolyte of said additive is added into the electrolyte.

There are at least two alternative methods for mixing said lithium salt, organic solvent, and additive together to make said electrolyte in the present invention. One method is to add individual ingredients of the additive to the organic solvent first and then add the lithium salt to the organic solvent after the additive has been mixed with the organic solvent thoroughly. In the alternative, the lithium salt is added to the organic solvent first and then the additive is added to the organic solvent after the lithium salt is dissolved in the organic solvent completely. The ingredients of the additive can be mixed together before being added to the organic solvent. Alternatively, the ingredients of the additive can be added individually to the organic solvent in random order without being mixed together beforehand. Because a lot of heat would be generated when the lithium salt is dissolved in the organic solvent and heating could increase the rate of dissolving for the additive, as a result, the first approach is used in the preferred embodiments. In the preferred embodiments, the electrolyte is heated so that the additive would dissolve quickly. The heating is performed under vacuum condition and the heating temperature is 30° C. to 90° C., preferably 45° C. to 70° C.; the length of heating is 5 to 60 minutes, preferably 10 to 20 minutes.

The lithium ion battery comprises of an electrode group and an electrolyte. The said electrode group comprises of a positive electrode, a negative electrode, and a separation membrane between the positive electrode and negative electrode. In particular, the electrolyte is fabricated under the methods of the present invention. However, since the invention concerns only improvements on the electrolytes of the lithium ion battery, there is not special limitation on the other components and structures of the lithium ion battery.

The positive electrodes can be various positive electrodes commonly used in the lithium ion battery. The positive electrode normally includes a current collector and the material for the positive electrode on or inside the current collector. The current collectors can be various commonly used current collectors, such as aluminum foil, copper foil and steel strip with nickel plated on the surface. In preferred embodiments, the aluminum foil is used for said current collector. The material for positive electrodes can be commonly used material for the positive electrode and normally contains the active material for the positive electrode, a binding agent and an optional conductive agent. The active material for the positive electrode can be the commonly used active material for the positive electrode in the lithium ion battery, for example, LiₓNi_{1-y}CoO₂ (0.9≦x≦1.1, 0≦y≦1.0), LiₘMn₂₋ₙBₙO₂ (B is transitional metal, 0.9≦m≦1.1, 0≦n≦1.0), and Li₁₊ₐM_{b}Mn_{2-b}O₄ (0.1≦a≦0.2, 0≦b≦1.0, M comprises of at least one from the following: lithium, boron, magnesium, aluminum, titanium, chromium, iron, cobalt, nickel, copper, zinc, gallium, yttrium, fluorine, iodine, sulfur).

There is no special limitation on the binding agent for the material for the positive electrode. The binding agents can be various binding agents commonly used in the lithium ion batteries. In preferred embodiments, said binding agent comprises of both a hydrophobic binding agent and a hydrophilic binding agent. There is no special limitation on the ratio between the hydrophobic binding agent and the hydrophilic binding agent. The ratio can be further determined based on the actual circumstances. For example, the weight ratio between the hydrophobic binding agent and hydrophilic binding agent can be 0.3:1 to 1:1. Said binding agent can be used in water solution, emulsion or solid form. In preferred embodiments, either water solution or emulsion is used and there is no special limitation on the concentration of either hydrophobic binding agent or hydrophilic binding agent. The concentration can be readily adjusted based on the viscosity of the paste for both positive and negative electrodes and the operation requirements. For example, the concentration of said hydrophilic binding agent can be 0.5 to 4 wt %, while the concentration of said hydrophobic binding agent can be 10 wt % to 80 wt %. The hydrophobic binding agent can be teflon (tetrafluoroethylene), styrene butadiene rubber or their mixture. The hydrophilic binding agent can be hydroxy propyl methylcellulose, carboxymethyl cellulose sodium, hydroxyethyl cellulose, polyvinyl alcohol or their mixture. The concentration of said binding agent is 0.01 wt % to 8 wt % of the total active material for the positive electrode. In preferred embodiments, the concentration is 1 wt % to 5 wt %.

The positive electrode material can selectively contain the commonly used conductive agents for the positive electrode. Since the conductive agent increases the electrode conductivity and decreases the battery internal resistance, as a result, a conductive agent is used in preferred embodiments of this invention. The concentration and the type of the conductive agent used are well known to the persons skilled in the art. For example, the concentration of the conductive agent is 0 wt % to 15 wt % of the total weight of the positive electrode material. In preferred embodiments, the concentration is 0 wt % to 10 wt % of the total weight of the positive electrode material. The conductive agent is at least one material selected from the following: conductive carbon black, acetylene black, nickel powder, copper powder, and conductive graphite.

The composition of the negative electrode is well known to persons skilled in the art. The negative electrode includes a current collector and the negative electrode material for the current collector on or inside the current collector. Said current collectors are well known to persons skilled in the art. For example, the current collector is at least one material selected from the following: copper foil, steel strip with nickel plated on the surface, steel strip with punching holes. Said active material for the negative electrode is well known to persons skilled in the art, which includes an active material for the negative electrode and an adhesive agent. Said active material for the negative electrode is the commonly used active substance in the lithium ion battery and is at least one material selected from the following: natural graphite, man-made graphite, petroleum coke, organic decomposition carbon, mesocarbon microbeads, carbon fiber, tutania and silicon alloy. Said adhesive agent is commonly used adhesive agent in the lithium ion battery and is at least one material selected from the following: polyvinyl alcohol, teflon (tetrafluoroethylene), hydroxy methyl cellulose (CMC) and styrene butadiene rubber (SBR). The concentration of the adhesive agent is normally 0.5 wt % to 8 wt % of the total weight of the active material for the negative electrode, preferably 2 wt % to 5 wt %.

The solvents for making the paste for both the positive and negative electrodes can be selected from most commonly used solvents. For example, the solvents can comprise of at least one solvent from the following: N-methylpyrrolidone (NMP), N,N-dimethyl formamide (DMF), N,N-diethylformamide (DEF), dimethyl sulfoxide (DMSO), tetrahydrofuran (THF), water and alcohol. Enough solvent is needed so that said paste can cover said conduct collector. Normally, enough solvent is needed so that the concentration of the active materials for the positive electrode is 40 wt % to 90 wt % in the paste, preferable 50 wt % to 85 wt %.

Said separation membrane has the characteristics of electrical insulation and liquid maintenance. The separation membrane is situated between the positive electrode and the negative electrode and is sealed inside the shell of the rechargeable battery along with the positive electrode, negative electrode and electrolyte. Said separation membrane can be the commonly used separation membrane. For example, the separation membrane can be selected from the following products made by well-known manufacturers: modified polyethylene felt, modified polypropylene felt, super-thin glass fiber felt, and compound membrane made of nylon felt (or vinylon felt) and polyolefine pore film with wettability through welding or binding.

The present invention provides methods of fabrication for the lithium ion battery. The methods comprise of the following steps:

the fabrication of the positive electrode and negative electrode;

the fabrication of the electrode group by placing a separation membrane between the positive electrode and negative electrode;

the insertion of said electrode group into the shell of the lithium ion battery;

the injection of said electrolyte into said shell; and

the sealing of the battery shell. In particular, said electrolyte is provided by present invention and all other steps are well known in the fields of lithium ion batteries.

The following embodiments further describe this invention.

### Embodiment 1

This embodiment describes a novel electrolyte, a lithium ion battery with said electrolyte and the methods of fabrication.

The fabrication of the electrolyte comprises of the following steps:

mixing ethylene carbonate:ethyl-methyl carbonate:dimethyl carbonate at a ratio of 1:1:1 in volume in 210 ml mixture solvent;

adding 11.2 grams additive to the solvent (the concentration of the fluoride benzene in said additive is 1.9 wt %; the concentration of the 1,3-propane sulfonic lactone in said additive is 18.9 wt %; the concentration of the biphenyl in said additive is 18.9 wt %; the concentration of the phenylcyclohexane is 56.5 wt %; the concentration of the tert-amylbenzene in said additive is 18.9 wt %; the concentration of the succinic anhydride in said additive is 1.9 wt %).

mixing the additive with the solvent thoroughly;

adding 31.90 grams LiPF6 to make a solvent at the concentration of 1.0 mol/L; and

heating the solvent for 12 hours at 50° C. in vacuum to obtain electrolyte of this embodiment with the concentration of the additive at 5.3 wt %.

The fabrication of the positive electrode comprises of the following steps:

dissolving 90 grams poly (vinylidene finoride) (ATOFINA, 761#PVDF) in 1350 grams of N-methyl-2-pyrrolidone (NMP) to obtain a binding agent solution;

mixing 2895 grams LiCoO₂ and 90 grams acetylene black powder thoroughly to obtain a mixture;

adding said mixture to said binding agent solution;

stirring said mixture in said solution thoroughly to obtain the paste for the positive electrode;

evenly spreading said paste onto both sides of an aluminum foil with a thickness of 20 μm;

drying said foil with the paste in vacuum at 125° C. for one hour;

pressing it to obtain the positive electrode plate; and

cutting the plate to obtain said positive electrode with a dimension of 550 mm (length)×43.8 mm (width)×125 μm (thickness). Each positive electrode contains 7.9 grams to 8.1 grams LiCoO₂.

The fabrication of the negative electrode comprises of the following steps:

dissolving 30 grams carboxymethyl cellulose (CMC) (Jiangmen Quantum Hi-Tech Biological Engineering Co., Ltd., model CMC 1500) and 75 grams butylbenzene rubber (SBR) latex (Nangtong Shen Hua Chemical Industrial Company Limited product, model TAIPOL1500E) in 1875 grams water;

stirring thoroughly to obtain a binding agent solution;

adding 1395 grams graphite (SODIFF company product, model DAG84) to said binding agent solution;

mixing thoroughly to obtain the paste for the negative electrodes;

evenly spreading said paste onto both sides of a copper foil with a thickness of 12 μm;

drying the foil with the paste in vacuum at 125° C. for one hour;

pressing it to obtain the negative electrode plate; and

cutting the plate to obtain said negative electrode with a dimension of 515 mm (length)×44.5 mm (width)×125 μm (thickness). Each negative electrode contains 3.8 grams to 4.1 grams graphite.

The fabrication of the lithium ion rechargeable battery:

wrapping said positive electrode, negative electrode with a polypropylene separator membrane with a thickness of 20 μm to obtain the electrode group for the lithium battery;

placing said electrode group into a aluminum battery shell with a dimension of 4 mm×34 mm×50 mm and welding;

injecting 2.8 ml electrolyte fabricated above into said aluminum battery shell; and

sealing said battery shell to obtain a lithium ion secondary battery with model number 043450A. The designed capacity is 850 mAh.

### Embodiments 2-13

The fabrication methods of the electrolytes and the lithium ion rechargeable batteries are the same as those in Embodiment 1. The differences are the composite of the additive, the ratio of each ingredient, the amount of additive, the concentration of the additive in the electrolyte, the heating temperature and heating time of the electrolyte, as described in Table 1 and Table 2 below.

TABLE 1

| Embodiments | No. 2 | No. 3 | No. 4 | No. 5 | No. 6 | No. 7 |
|---|---|---|---|---|---|---|
| Concentration of fluoride | 10.7 | 7.9 | 14.0 | 28.2 | 29.4 | 10.6 |
| benzene in the additive (wt %) | | | | | | |
| Concentration of 1,3-propane | 20.3 | 47.2 | 12.8 | 6.7 | 24.9 | 28.9 |
| sulfonic lactone in the | | | | | | |
| additive (wt %) | | | | | | |
| Concentration of biphenyl | 0.5 | 23.6 | 5.6 | 13.4 | 29.9 | 12.8 |
| in the additive (wt %) | | | | | | |
| Concentration of | 21.3 | 15.7 | 33.5 | 8.7 | 0.9 | 12.8 |
| phenylcyclohexane in the | | | | | | |
| additive (wt %) | | | | | | |
| Concentration of tert- | 17.3 | 1.7 | 20.1 | 21.5 | 9.9 | 30.2 |
| amylbenzene in the additive | | | | | | |
| (wt %) | | | | | | |
| Concentration of succinic | 29.9 | 3.9 | 14.0 | 21.5 | 5.0 | 4.7 |
| anhydride in the additive | | | | | | |
| (wt %) | | | | | | |
| Additive added (grams) | 41.63 | 26.84 | 37.83 | 31.49 | 42.48 | 49.66 |
| Concentration of the additive | 19.7 | 12.7 | 17.9 | 14.9 | 20.1 | 23.5 |
| in the electrolytes (wt %) | | | | | | |
| Heating temperature for the | 45 | 50 | 55 | 60 | 65 | 70 |
| electrolytes (° C.) | | | | | | |
| Heating time for the | 10 | 11 | 12 | 13 | 14 | 15 |
| electrolytes (minutes) | | | | | | |

TABLE 2

| | No. 8 | | No. 9 | | No. 10 | | No. 11 | | No. 12 | | No. 13 | |
|---|---|---|---|---|---|---|---|---|---|---|---|---|
| | Com- | Concen- | Com- | Concen- | Com- | Concen- | Com- | Concen- | Com- | Concen- | Com- | Concen- |
| Embodiments | posites | tration | posites | tration | posites | tration | posites | tration | posites | tration | posites | tration |
| The concen- | chloro- | 90 | bromo- | 0.3 | 2-chloro- | 1.4 | 3-chloro- | 0.5 | 4-chloro- | 1 | Chloro- | 3 |
| tration of | benzene | | benzene | | toluene | | toluene | | ethyl- | | methyl- | |
| halogeno- | | | | | | | | | benzene | | benzene | |
| benzene | fluoro- | 5 | | | | | | | | | | |
| and/or its | benzene | | | | | | | | | | | |
| homologs in | | | | | | | | | | | | |
| the additive | | | | | | | | | | | | |
| (wt %) | | | | | | | | | | | | |
| The concen- | ethylene | 2 | propylene | 95 | Dimethyl | 0.1 | diethyl | 0.5 | Dimethyl | 1 | 1,3- | 1 |
| tration of | sulfite | | sulfite | | sulfite | | sulfite | | sulfoxide | | Propane | |
| the O═S═O | | | | | | | | | | | sultone | |
| bond | | | | | | | | | | | | |
| compounds | | | | | | | | | | | | |
| in the | | | | | | | | | | | | |
| additive | | | | | | | | | | | | |
| (wt %) | | | | | | | | | | | | |
| The concen- | 3-cyclo- | 1 | 3-cyclo- | 1 | trebi- | 90 | trebi- | 0.1 | 1,3-bi- | 1 | 1,3-bi- | 0.7 |
| tration of | hexyl | | hexyl | | phenyl | | phenyl | | phenyl | | phenyl | |
| biphenyl | biphenyl | | biphenyl | | | | | | cyclo- | | cyclo- | |
| and/or its | | | | | | | | | hexane | | hexane | |
| homologs | | | | | Biphenyl | 4 | | | | | | |
| in the | | | | | | | | | | | | |
| additive | | | | | | | | | | | | |
| (wt %) | | | | | | | | | | | | |
| The concen- | 1,3- | 1.4 | 1,3- | 1 | 1,3- | 0.5 | phenyl- | 95 | phenyl- | 0.3 | phenyl- | 1 |
| tration of | dicyclo- | | dicyclo- | | dicyclo- | | cyclo- | | cyclo- | | cyclo- | |
| phenylcyclo- | hexyl- | | hexyl- | | hexyl- | | hexane | | hexane | | hexane | |
| hexane and/or | benzene | | benzene | | benzene | | | | | | | |
| its homologs | | | | | | | | | | | | |
| in the | | | | | | | | | | | | |
| additive | | | | | | | | | | | | |
| (wt %) | | | | | | | | | | | | |
| The concen- | tert- | 0.5 | tert- | 1 | tert- | 2 | tert- | 3 | tert- | 96 | tert- | 0.3 |
| tration of | Butyl | | hexyl | | Amyl- | | Amyl- | | Amyl- | | Amyl- | |
| teraklyl- | benzene | | benzene | | benzene | | benzene | | benzene | | benzene | |
| benzenes | | | | | | | | | | | | |
| in the | | | | | | | | | | | | |
| additive | | | | | | | | | | | | |
| (wt %) | | | | | | | | | | | | |
| The concen- | Succinic | 0.1 | Succinic | 1.7 | Dimethyl | 2 | Dimethyl | 0.9 | 3-methyl- | 0.7 | Hexane | 94 |
| tration of | an- | | an- | | adipate | | adipate | | hexane | | dioic | |
| di-cycladipate | hydride | | hydride | | | | | | dioic | | an- | |
| and/or its | | | | | | | | | an- | | hydride | |
| homologs | | | | | | | | | hydride | | | |
| in the | | | | | | | | | | | | |
| additive | | | | | | | | | | | | |
| (wt %) | | | | | | | | | | | | |

| | | | | | | |
|---|---|---|---|---|---|---|
| Additive | 4.23 | 8.45 | 12.68 | 16.91 | 21.13 | 42.26 |
| added (grams) | | | | | | |
| The concen- | 2 | 4 | 6 | 8 | 10 | 20 |
| tration of | | | | | | |
| the additive | | | | | | |
| in the | | | | | | |
| electrolytes | | | | | | |
| (wt %) | | | | | | |
| Heating | 45 | 50 | 55 | 60 | 65 | 70 |
| Temperature | | | | | | |
| for the | | | | | | |
| Electrolytes | | | | | | |
| (° C.) | | | | | | |
| Heating Time | 16 | 17 | 18 | 19 | 20 | 20 |
| for the | | | | | | |
| Electrolytes | | | | | | |
| (minutes) | | | | | | |

### Comparison Example 1

This comparison example describes the fabrication of the electrolytes and lithium ion batteries under the current technologies.

The electrolyte additives and the lithium ion rechargeable batteries are fabricated under the identical methods as in Embodiment 1. The only difference is that no additive is added to the electrolyte.

### Comparison Example 2

This comparison example describes the fabrication of the electrolytes and lithium ion batteries under the current technologies.

The electrolyte additives and the lithium ion rechargeable batteries are fabricated under the identical methods as in Embodiment 1. The only difference is that the additive comprised of 6.34 grams biphenyl solid powder and 4.23 grams phenylcyclohexane is added to the electrolyte to improve the overcharge safety properties of the lithium ion battery. The concentration of said additive is about 5 wt % of the total weight of electrolyte.

### Lithium Ion Rechargeable Batteries Properties Test

All the lithium ion rechargeable batteries fabricated under Embodiments 1-13 and Comparison Examples 1-2 are activated to have electricity performance. The battery voltage is no smaller than 3.85 v after the activation.

### (1) Overcharge Safety Properties Test for the Lithium Ion Batteries

The overcharge safety properties test of Embodiments 1-13 and Comparison Example 1-2 can be tested under 16-30° C. and relative humidity of 25% to 85%. The method for testing of each battery comprises of the following steps:

cleaning the battery surface after activation;

discharging the battery to 3.0 v with 850 mA;

adjusting the value of the output current of a constant current and constant voltage electrical to that required by the overcharge safety test: output current at 850 mA or 2000 mA and output voltage at 5 v;

attaching the temperature sensor of a thermocouple sensor to the middle of the battery's side with heat-resistant tapes;

evenly wrapping a layer of loose asbestos with a thickness of 12 mm onto the battery's surface and pressing the layer to a thickness of 6-7 mm during the wrapping;

turning off the electrical source and connecting said battery with universal meter and the constant current and constant voltage electrical source;

putting the battery in a safety cabinet;

turning on said electrical source to charge the battery;

starting the timer;

turning on the universal meter to monitor the voltage change;

recording the change in battery's temperature, voltage and electrical current;

observing whether one of the following occurs: leakage, breach, fume, explosion, or ignition; In particular, recording the time and highest surface temperature of the battery at the time of occurrence; and

terminating the test when any of the following conditions occur: the battery's surface temperature rises above 200° C.; the battery explodes; the overcharge electrical current drops below 50 mA; the battery's voltage reaches the specified voltage and its surface temperature drops below 40° C.

If the test terminates under one of the said conditions and there is no abnormal occurrence such as leakage, breach, fume, explosion, or ignition, then the battery passes the overcharging safety test. Otherwise, the battery fails the overcharging safety test.

Table 3 shows that a battery with an electrolyte that is an embodiment of the present invention has distinctly improved overcharging safety properties over batteries with electrolytes fabricated in the Comparison Example 1. Moreover, it has comparable overcharging safety properties with batteries with electrolytes with anti-overcharging additive fabricated in the Comparison Example 2.

TABLE 3
Results of Overcharging Safety Tests

| | 1C-12 v Overcharge | | 1C-18.5 v Overcharge | |
|---|---|---|---|---|
| Electrolytes | Pass Status | Observation | Pass Status | Observation |
| Embodiment 1 | Pass | Volume Expansion, no | Pass | Volume Expansion, no |
| | | Explosion and no Fire | | Explosion and no Fire |
| Embodiment 2 | Pass | Volume Expansion, no | Pass | Volume Expansion, no |
| | | Explosion and no Fire | | Explosion and no Fire |
| Embodiment 3 | Pass | Volume Expansion, no | Pass | Volume Expansion, no |
| | | Explosion and no Fire | | Explosion and no Fire |
| Embodiment 4 | Pass | Volume Expansion, no | Pass | Volume Expansion, no |
| | | Explosion and no Fire | | Explosion and no Fire |
| Embodiment 5 | Pass | Volume Expansion, no | Pass | Volume Expansion, no |
| | | Explosion and no Fire | | Explosion and no Fire |
| Embodiment 6 | Pass | Volume Expansion, no | Pass | Volume Expansion, no |
| | | Explosion and no Fire | | Explosion and no Fire |
| Embodiment 7 | Pass | Volume Expansion, no | Pass | Volume Expansion, no |
| | | Explosion and no Fire | | Explosion and no Fire |
| Embodiment 8 | Pass | Volume Expansion, no | Pass | Volume Expansion, no |
| | | Explosion and no Fire | | Explosion and no Fire |
| Embodiment 9 | Pass | Volume Expansion, no | Pass | Volume Expansion, no |
| | | Explosion and no Fire | | Explosion and no Fire |
| Embodiment 10 | Pass | Volume Expansion, no | Pass | Volume Expansion, no |
| | | Explosion and no Fire | | Explosion and no Fire |
| Embodiment 11 | Pass | Volume Expansion, no | Pass | Volume Expansion, no |
| | | Explosion and no Fire | | Explosion and no Fire |
| Embodiment 12 | Pass | Volume Expansion, no | Pass | Volume Expansion, no |
| | | Explosion and no Fire | | Explosion and no Fire |
| Embodiment 13 | Pass | Volume Expansion, no | Pass | Volume Expansion, no |
| | | Explosion and no Fire | | Explosion and no Fire |
| Comparable | Fail | Explosion at 91 minutes | Fail | Explosion at 96 minutes |
| Example 1 | | and 328° C. | | and 338° C. |
| Comparable | Pass | Volume Expansion, no | Pass | Volume Expansion, no |
| Example 2 | | Explosion and no Fire | | Explosion and no Fire |

### (2) High Temperature Storage Stability Test

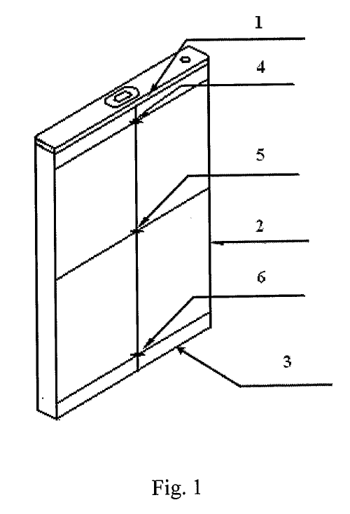

The high temperature stability of Embodiments 1-13 and Comparison Example 1-2 can be tested and the method of testing each battery comprises of the following steps:
charging the battery to 4.2 v with 850 mA (1 C) constant current initially;
charging the battery with 4.2 v constant voltage current with the initial charging current being 100 mA and the cut-off current being 20 mA;
discharging the battery to 3 v with 850 mA electrical current;
recording the battery's initial capacity;
charging the battery to 4.2 v with 850 mA (1 C);
cooling down the battery for 30 minutes;
recording the battery's internal resistance, voltage and thickness in reference to the middle measuring pint (5) as shown in FIG. 1;
storing the battery in a heating cabinet at 85° C. for 48 hours;
removing the battery from the heating cabinet and leaving it at room temperature for 30 minutes;
recording the battery's internal resistance, voltage and thickness in reference to the middle measuring pint (5) as shown in FIG. 1;
discharging the battery to 3 v with 850 mA (1 C) electrical current;
recording the battery's storage capacity;
charging the battery to 4.2 v with 850 mA (1 C) and subsequently discharging the battery to 3 v with 850 mA (1 C);
repeating above-described cycle three times;
recording the battery's recovery capacity in the last cycle;
charging the battery to 4.2 v with 850 mA;
storing the battery at room temperature for 30 minutes;
recording the battery's recovery resistance and recovery thickness; and
calculating the self-discharging rate, capacity recovery rate and internal resistance change rate based on the following formula: self-discharging rate=(initial capacity-storage capacity)/initial capacity*100%; capacity recovery rate=recovery capacity/initial capacity*100%; internal resistance rate=recovery internal resistance increase/initial internal resistance*100%.

TABLE 4
Results of 48 hours storage at 85 C.

| | Storage | Recovery | | | | | |
|---|---|---|---|---|---|---|---|
| | Internal | Internal | Storage | Recovery | | | Internal |
| Electrolytes | Resistance | Resistance | Thickness | Thickness | Self- | Capacity | Resistance |
| and | Increase | Increase | Increase | Increase | Discharge | Recovery | Recovery |
| Conditions | (mΩ) | (mΩ) | (mm) | (mm) | Rate (%) | Rate (%) | Rate (%) |
| Embodiment | 15.8 | 12 | 1.56 | 0.96 | 26 | 83.1 | 36.8 |
| No. 1 | | | | | | | |
| Embodiment | 15.9 | 15 | 1.79 | 1.03 | 26.9 | 81.9 | 38.5 |
| No. 2 | | | | | | | |
| Embodiment | 17.8 | 18 | 1.85 | 1.1 | 27.5 | 80.7 | 39.7 |
| No. 3 | | | | | | | |
| Embodiment | 16.5 | 16 | 1.8 | 1.06 | 27.3 | 81.5 | 38.9 |
| No. 4 | | | | | | | |
| Embodiment | 15.7 | 14 | 1.62 | 0.99 | 26.3 | 82.7 | 37.6 |
| No. 5 | | | | | | | |
| Embodiment | 20.7 | 22 | 1.93 | 1.18 | 29.5 | 80.9 | 42.5 |
| No. 6 | | | | | | | |
| Embodiment | 18.4 | 19 | 1.89 | 1.13 | 28 | 80.4 | 40.4 |
| No. 7 | | | | | | | |
| Embodiment | 17.6 | 17 | 1.86 | 1.12 | 28.5 | 81.7 | 39.2 |
| No. 8 | | | | | | | |
| Embodiment | 17.5 | 16 | 1.86 | 1.08 | 27.3 | 82.5 | 38.9 |
| No. 9 | | | | | | | |
| Embodiment | 16.7 | 15 | 1.66 | 0.98 | 27.3 | 82.7 | 37.8 |
| No. 10 | | | | | | | |
| Embodiment | 18.7 | 20 | 1.94 | 1.18 | 29.6 | 81.9 | 42.2 |
| No. 11 | | | | | | | |
| Embodiment | 15.8 | 16 | 1.56 | 0.98 | 26.2 | 83.1 | 36.8 |
| No. 12 | | | | | | | |
| Embodiment | 15.8 | 19 | 1.79 | 1.06 | 26.9 | 81.8 | 38.6 |
| No. 13 | | | | | | | |
| Comparison | 23.3 | 25 | 1.96 | 1.23 | 30.1 | 76.2 | 44.8 |
| Example | | | | | | | |
| No. 1 | | | | | | | |
| Comparison | 24.5 | 30 | 2.14 | 1.3 | 35.9 | 73.2 | 49.5 |
| Example | | | | | | | |
| No. 2 | | | | | | | |

Table 4 shows that batteries with electrolytes that are embodiments of the present invention have distinctly improved stabilities over batteries with electrolytes fabricated in the Comparison Example 1 and 2 after 48 hours storage at 85° C. Therefore, a battery with an electrolyte that is an embodiment of the present invention has much better high temperature storage stability properties.

### (3) Cycling Properties of the Lithium Ion Batteries

The battery capacities of Embodiments 1-13 and Comparison Example 1-2 can be tested under constant temperature and relative humidity of 25% to 85%. The method for the testing of each battery comprises of the following steps:

measuring the battery's thickness in reference to the upper measuring point (4), middle measuring point (5) and lower measuring point (6) as shown in FIG. 1 using a vernier caliper. In particular, the upper measuring point is 5 mm from the top cover (1), 17 mm from the side line (2); the middle measuring point is 25 mm from the top cover (1), 17 mm from the side line (2); the lower measuring point is 5 mm from the bottom line (3), 17 mm from the side line (2);

using a secondary battery property test equipment BS-9300 (R) for testing;

charging the battery to 4.2 v with 850 mA (1 C) constant current initially,

charging the battery with 4.2 v constant voltage current with the initial charging current being 100 mA and the cutoff current being 20 mA;

discharging the battery to 3 v with 850 mA;

recording the battery's initial capacity;

repeating above-described cycle and recording the battery's capacity at the end of 10, 30, 60, 100, 150, 200, 250, 350 and 400 times of cycling;

calculating the battery capacity retention rate based the following formula: capacity retention rate=capacity after cycling/initial capacity*100%;

measuring the battery's thickness at the end of the 100, 200, 300 and 400 times of cycling. The battery thickness difference is calculated based in the following formula: thickness difference (mm)=battery thickness after cycling (mm)-battery thickness before cycling (mm). The results of the capacity retention rate are shown in Table 5. The results of battery thickness measurement are shown in Table 6 and Table 7.

TABLE 5
The Results of the Lithium Ion Batteries Capacity Retention Rate Measurement

| | Em- | Em- | Em- | Em- | Em- | Em- | Em- | Em- | Em- | Em- | Em- | Em- | Em- | Compar- | Compar- |
|---|---|---|---|---|---|---|---|---|---|---|---|---|---|---|---|
| | bodi- | bodi- | bodi- | bodi- | bodi- | bodi- | bodi- | bodi- | bodi- | bodi- | bodi- | bodi- | bodi- | ison | ison |
| Cycling | ment | ment | ment | ment | ment | ment | ment | ment | ment | ment | ment | ment | ment | Exam- | Exam- |
| Times | No. 1 | No. 2 | No. 3 | No. 4 | No. 5 | No. 6 | No. 7 | No. 8 | No. 9 | No. 10 | No. 11 | No. 12 | No. 13 | ple 1 | ple 2 |
| 10 | 98.5 | 99.1 | 98.6 | 99.1 | 98.7 | 99.3 | 99.3 | 99.2 | 99.0 | 99.0 | 99.0 | 97.9 | 97.9 | 98.5 | 97.8 |
| 30 | 97.2 | 98.0 | 94.6 | 96.0 | 95.5 | 98.5 | 98.4 | 98.1 | 96.7 | 96.1 | 96.5 | 95.3 | 95.7 | 94.3 | 95.1 |
| 60 | 96.5 | 97.0 | 93.4 | 95.6 | 94.6 | 97.7 | 97.1 | 97.2 | 96.2 | 95.7 | 95.9 | 94.6 | 93.8 | 92.1 | 92.4 |
| 100 | 93.3 | 94.2 | 90.9 | 92.9 | 90.3 | 95.7 | 95.5 | 95.0 | 94.5 | 93.0 | 92.7 | 92.1 | 90.1 | 90.1 | 90.2 |
| 150 | 91.6 | 93.4 | 89.7 | 92.0 | 87.9 | 94.2 | 94.3 | 93.5 | 93.1 | 91.8 | 91.5 | 89.5 | 87.2 | 86.9 | 85.2 |
| 200 | 87.5 | 91.1 | 84.9 | 88.2 | 85.1 | 91.1 | 90.8 | 89.4 | 89.2 | 89.0 | 88.4 | 86.3 | 85.7 | 84.2 | 83.5 |
| 250 | 85.7 | 88.7 | 83.0 | 87.0 | 83.7 | 89.7 | 88.8 | 88.1 | 87.4 | 88.1 | 87.7 | 84.5 | 82.9 | 82.1 | 81.1 |
| 300 | 83.8 | 84.2 | 82.7 | 84.0 | 82.8 | 87.7 | 86.4 | 85.2 | 85.3 | 85.2 | 84.5 | 83.2 | 81.7 | 80.7 | 80.2 |
| 350 | 82.5 | 82.9 | 82.1 | 81.9 | 82.0 | 84.3 | 83.1 | 82.5 | 82.1 | 82.4 | 81.7 | 81.4 | 81.1 | 80.1 | 78.1 |
| 400 | 81.3 | 81.6 | 81.2 | 80.9 | 81.1 | 81.9 | 81.7 | 81.3 | 81.1 | 81.5 | 81.2 | 81.0 | 80.9 | 75.8 | 75.0 |

TABLE 6
The Results of the Lithium Ion Batteries Thickness Measurement

| | | | | Thickness | | Thickness | | Thickness | | Thickness |
|---|---|---|---|---|---|---|---|---|---|---|
| | | | | Difference | | Difference | | Difference | | Difference |
| | | | After 100 | After 100 | After 200 | After 200 | After 300 | After 300 | After 400 | After 400 |
| | | Before | Times of | Times of | Times of | Times of | Times of | Times of | Times of | Times of |
| | Measuring | Cycling | Cycling | Cycling | Cycling | Cycling | Cycling | Cycling | Cycling | Cycling |
| | Position | (mm) | (mm) | (mm) | (mm) | (mm) | (mm) | (mm) | (mm) | (mm) |
| Embodiment | Upper Part | 4.53 | 4.69 | 0.16 | 4.69 | 0.16 | 4.88 | 0.35 | 5.00 | 0.47 |
| No. 1 | Middle Part | 4.49 | 4.62 | 0.13 | 4.74 | 0.25 | 4.92 | 0.43 | 5.04 | 0.55 |
| | Lower Part | 4.56 | 4.70 | 0.14 | 4.72 | 0.16 | 4.90 | 0.34 | 5.01 | 0.45 |
| | Average Thickness | 4.53 | 4.67 | 0.14 | 4.72 | 0.19 | 4.90 | 0.37 | 5.02 | 0.49 |
| Embodiment | Upper Part | 4.55 | 4.63 | 0.08 | 4.79 | 0.24 | 4.93 | 0.38 | 5.00 | 0.45 |
| No. 2 | Middle Part | 4.51 | 4.66 | 0.15 | 4.86 | 0.35 | 4.98 | 0.47 | 5.09 | 0.58 |
| | Lower Part | 4.59 | 4.71 | 0.12 | 4.81 | 0.22 | 4.95 | 0.36 | 5.03 | 0.44 |
| | Average Thickness | 4.55 | 4.67 | 0.12 | 4.82 | 0.27 | 4.95 | 0.40 | 5.04 | 0.49 |
| Embodiment | Upper Part | 4.53 | 4.66 | 0.13 | 4.75 | 0.22 | 4.89 | 0.36 | 4.98 | 0.45 |
| No. 3 | Middle Part | 4.49 | 4.69 | 0.20 | 4.88 | 0.39 | 4.96 | 0.47 | 5.06 | 0.57 |
| | Lower Part | 4.55 | 4.74 | 0.19 | 4.82 | 0.27 | 4.91 | 0.36 | 5.00 | 0.45 |
| | Average Thickness | 4.52 | 4.70 | 0.17 | 4.82 | 0.29 | 4.92 | 0.40 | 5.01 | 0.49 |
| Embodiment | Upper Part | 4.5 | 4.67 | 0.17 | 4.74 | 0.24 | 4.87 | 0.37 | 4.98 | 0.48 |
| No. 4 | Middle Part | 4.49 | 4.69 | 0.20 | 4.84 | 0.35 | 4.92 | 0.43 | 5.05 | 0.56 |
| | Lower Part | 4.52 | 4.70 | 0.18 | 4.76 | 0.24 | 4.84 | 0.32 | 4.96 | 0.44 |
| | Average Thickness | 4.50 | 4.69 | 0.18 | 4.78 | 0.28 | 4.88 | 0.37 | 5.00 | 0.49 |
| Embodiment | Upper Part | 4.52 | 4.69 | 0.17 | 4.78 | 0.26 | 4.84 | 0.32 | 4.94 | 0.42 |
| No. 5 | Middle Part | 4.49 | 4.70 | 0.21 | 4.79 | 0.30 | 4.90 | 0.41 | 5.02 | 0.53 |
| | Lower Part | 4.55 | 4.73 | 0.18 | 4.76 | 0.21 | 4.87 | 0.32 | 4.98 | 0.43 |
| | Average Thickness | 4.52 | 4.71 | 0.19 | 4.78 | 0.26 | 4.87 | 0.35 | 4.98 | 0.46 |
| Embodiment | Upper Part | 4.52 | 4.72 | 0.20 | 4.77 | 0.25 | 4.87 | 0.35 | 4.95 | 0.43 |
| No. 6 | Middle Part | 4.47 | 4.74 | 0.27 | 4.9 | 0.43 | 4.93 | 0.46 | 5.05 | 0.58 |
| | Lower Part | 4.55 | 4.76 | 0.21 | 4.85 | 0.30 | 4.9 | 0.35 | 4.97 | 0.42 |
| | Average Thickness | 4.51 | 4.74 | 0.23 | 4.84 | 0.33 | 4.90 | 0.39 | 4.99 | 0.48 |
| Embodiment | Upper Part | 4.50 | 4.67 | 0.17 | 4.75 | 0.25 | 4.86 | 0.36 | 4.98 | 0.48 |
| No. 7 | Middle Part | 4.45 | 4.69 | 0.24 | 4.88 | 0.43 | 4.92 | 0.47 | 4.99 | 0.54 |
| | Lower Part | 4.53 | 4.74 | 0.21 | 4.82 | 0.29 | 4.84 | 0.31 | 4.95 | 0.42 |
| | Average Thickness | 4.49 | 4.70 | 0.21 | 4.82 | 0.32 | 4.87 | 0.38 | 4.97 | 0.48 |
| Embodiment | Upper Part | 4.52 | 4.69 | 0.17 | 4.73 | 0.21 | 4.88 | 0.36 | 4.97 | 0.45 |
| No. 8 | Middle Part | 4.44 | 4.70 | 0.26 | 4.85 | 0.41 | 4.93 | 0.49 | 5.00 | 0.56 |
| | Lower Part | 4.51 | 4.72 | 0.21 | 4.84 | 0.33 | 4.85 | 0.34 | 4.97 | 0.46 |
| | Average Thickness | 4.49 | 4.70 | 0.21 | 4.81 | 0.32 | 4.89 | 0.40 | 4.98 | 0.49 |

TABLE 7
The Results of the Lithium Ion Batteries Thickness Measurement

| | | | | Thickness | | Thickness | | Thickness | | Thickness |
|---|---|---|---|---|---|---|---|---|---|---|
| | | | | Difference | | Difference | | Difference | | Difference |
| | | | After 100 | After 100 | After 200 | After 200 | After 300 | After 300 | After 400 | After 400 |
| | | Before | Times of | Times of | Times of | Times of | Times of | Times of | Times of | Times of |
| | Measuring | Cycling | Cycling | Cycling | Cycling | Cycling | Cycling | Cycling | Cycling | Cycling |
| | Position | (mm) | (mm) | (mm) | (mm) | (mm) | (mm) | (mm) | (mm) | (mm) |
| Embodiment | Upper | 4.49 | 4.69 | 0.20 | 4.77 | 0.28 | 4.88 | 0.39 | 4.97 | 0.48 |
| No. 9 | Part | | | | | | | | | |
| | Middle | 4.48 | 4.66 | 0.18 | 4.86 | 0.38 | 4.96 | 0.48 | 5.02 | 0.54 |
| | Part | | | | | | | | | |
| | Lower | 4.50 | 4.72 | 0.22 | 4.75 | 0.25 | 4.85 | 0.35 | 4.94 | 0.44 |
| | Part | | | | | | | | | |
| | Average | 4.49 | 4.69 | 0.20 | 4.79 | 0.30 | 4.90 | 0.41 | 4.98 | 0.49 |
| | Thickness | | | | | | | | | |
| Embodiment | Upper | 4.50 | 4.72 | 0.22 | 4.80 | 0.30 | 4.87 | 0.37 | 4.97 | 0.47 |
| No. 10 | Part | | | | | | | | | |
| | Middle | 4.48 | 4.69 | 0.21 | 4.84 | 0.36 | 4.88 | 0.40 | 4.99 | 0.51 |
| | Part | | | | | | | | | |
| | Lower | 4.52 | 4.76 | 0.24 | 4.83 | 0.31 | 4.90 | 0.38 | 4.99 | 0.47 |
| | Part | | | | | | | | | |
| | Average | 4.50 | 4.72 | 0.22 | 4.82 | 0.32 | 4.88 | 0.38 | 4.98 | 0.48 |
| | Thickness | | | | | | | | | |
| Embodiment | Upper | 4.54 | 4.70 | 0.16 | 4.77 | 0.23 | 4.92 | 0.38 | 5.03 | 0.49 |
| No. 11 | Part | | | | | | | | | |
| | Middle | 4.50 | 4.69 | 0.19 | 4.78 | 0.28 | 4.92 | 0.42 | 5.04 | 0.54 |
| | Part | | | | | | | | | |
| | Lower | 4.56 | 4.77 | 0.21 | 4.80 | 0.24 | 4.85 | 0.29 | 4.98 | 0.42 |
| | Part | | | | | | | | | |
| | Average | 4.53 | 4.72 | 0.19 | 4.78 | 0.25 | 4.90 | 0.36 | 5.02 | 0.48 |
| | Thickness | | | | | | | | | |
| Embodiment | Upper | 4.56 | 4.79 | 0.23 | 4.87 | 0.31 | 4.95 | 0.39 | 5.00 | 0.44 |
| No. 12 | Part | | | | | | | | | |
| | Middle | 4.51 | 4.81 | 0.30 | 4.85 | 0.34 | 4.99 | 0.48 | 5.05 | 0.54 |
| | Part | | | | | | | | | |
| | Lower | 4.58 | 4.82 | 0.24 | 4.88 | 0.30 | 5.00 | 0.42 | 5.06 | 0.48 |
| | Part | | | | | | | | | |
| | Average | 4.55 | 4.81 | 0.26 | 4.87 | 0.32 | 4.98 | 0.43 | 5.04 | 0.49 |
| | Thickness | | | | | | | | | |
| Embodiment | Upper | 4.52 | 4.77 | 0.25 | 4.88 | 0.36 | 4.99 | 0.47 | 5.03 | 0.51 |
| No. 13 | Part | | | | | | | | | |
| | Middle | 4.56 | 4.80 | 0.24 | 4.90 | 0.34 | 4.98 | 0.42 | 5.04 | 0.48 |
| | Part | | | | | | | | | |
| | Lower | 4.59 | 4.82 | 0.23 | 4.90 | 0.31 | 4.94 | 0.35 | 5.06 | 0.47 |
| | Part | | | | | | | | | |
| | Average | 4.56 | 4.80 | 0.24 | 4.89 | 0.34 | 4.97 | 0.41 | 5.04 | 0.49 |
| | Thickness | | | | | | | | | |
| Comparison | Upper | 4.57 | 4.96 | 0.39 | 5.10 | 0.53 | 5.19 | 0.62 | 5.37 | 0.80 |
| Example 1 | Part | | | | | | | | | |
| | Middle | 4.57 | 4.90 | 0.33 | 5.15 | 0.58 | 5.24 | 0.67 | 5.40 | 0.83 |
| | Part | | | | | | | | | |
| | Lower | 4.59 | 4.97 | 0.38 | 5.10 | 0.51 | 5.2 | 0.61 | 5.39 | 0.80 |
| | Part | | | | | | | | | |
| | Average | 4.58 | 4.94 | 0.37 | 5.12 | 0.54 | 5.21 | 0.63 | 5.39 | 0.81 |
| | Thickness | | | | | | | | | |
| Comparison | Upper | 4.54 | 4.90 | 0.36 | 5.13 | 0.59 | 5.24 | 0.70 | 5.37 | 0.83 |
| Example 2 | Part | | | | | | | | | |
| | Middle | 4.58 | 4.88 | 0.30 | 5.17 | 0.59 | 5.27 | 0.69 | 5.38 | 0.80 |
| | Part | | | | | | | | | |
| | Lower | 4.60 | 4.92 | 0.32 | 5.11 | 0.51 | 5.25 | 0.65 | 5.39 | 0.79 |
| | Part | | | | | | | | | |
| | Average | 4.57 | 4.90 | 0.33 | 5.14 | 0.56 | 5.25 | 0.68 | 5.38 | 0.81 |
| | Thickness | | | | | | | | | |

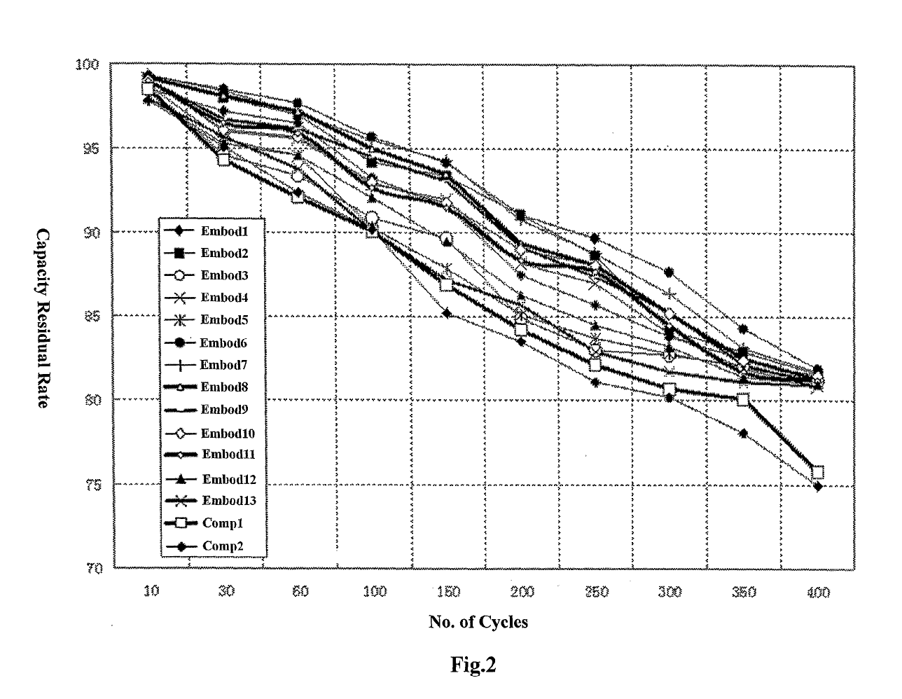

Table 5, Table 6, Table 7 and FIG. 2 show that a battery with an electrolyte that is an embodiment of the present invention has distinctly improved cycling properties over batteries with electrolytes that are fabricated in the Comparison Example 2. For example, the battery with an electrolyte that is an embodiment still maintains more than 80 percent of the initial capacity after 400 times of cycling and has much smaller increase in the thickness than the battery with electrolyte fabricated in the Comparison Example 2. Moreover, the battery with an electrolyte that is an embodiment has much higher capacity retention rate and smaller increase in the thickness than the battery with electrolyte fabricated in the Comparison Example 1.

In particular, a comparison between a battery with an electrolyte that is the embodiment 5 and a battery with an electrolyte that is fabricated in the Comparison Example 2 is very illustrative. First, both have very good overcharging safety properties and show only slight volume expansion in the overcharging safety test with 1 C (850 mAh) current at 12 v; second, the former has much improved high temperature storage stability properties. After 48 hours storage at 85° C., the former has 82.7% capacity recovery rate. In contrast, the latter has only 73.2% capacity recovery rate; lastly, the former have much better cycling properties than the latter. After 400 times of charging-discharging cycling, the former has only 0.46 mm increase in the thickness while the latter has 0.81 mm. Moreover, the former has 81.9% electrical capacity retention rate while the latter has only 75%.

As shown by the test results described above, a lithium ion battery with an electrolyte that is an embodiment of the present invention has distinctly improved overcharge safety properties, high-temperature storage stability properties and cycling properties.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but also all those other and further alterations and modifications as would be apparent to those of ordinary skilled in the art.

1. An electrolyte having an additive wherein the additive comprises:
at least one of halogeno-benzene or its homolog;
S═O bond compound;
at least one of biphenyl or its homolog;
at least one of phenylcyclohexane or its homolog;
teraklylbenzene; and
at least one of di-cycladipate or its homolog.

2. The electrolyte of claim 1 wherein
the weight of the additive is 2 wt % to 25 wt % of the weight of the electrolyte.

3. The electrolyte of claim 2 wherein
the weight of the additive is 10 wt % to 15 wt % of the weight of the electrolyte.

4. The electrolyte of claim 1 wherein
the weight of the at least one of halogeno-benzene or its homolog is 0.3 wt % to 95 wt % of the weight of the additive;
the weight of the S═O bond compound is 0.1 wt % to 95 wt % of the weight of the additive;
the weight of the at least one of biphenyl or its homolog is 0.1 wt % to 94 wt % of the weight of the additive;
the weight of the at least one of phenylcyclohexane or its homolog is 0.3 wt % to 95 wt % of the weight of the additive;
the weight of the teraklylbenzene is 0.3 wt % to 96 wt % of the weight of the additive; and
the weight of the at least one of di-cycladipate or its homolog is 0.1 wt % to 94 wt % of the weight of the additive.

5. The electrolyte of claim 4 wherein
the weight of the at least one of halogeno-benzene or its homolog is 5 wt % to 30 wt % of the weight of the additive;
the weight of the S═O bond compound is 12 wt % to 37 wt % of the weight of the additive;
the weight of the at least one of biphenyl or its homolog is 3 wt % to 28 wt % of the weight of the additive;
the weight of the at least one of phenylcyclohexane or its homolog is 6 wt % to 36 wt % of the weight of the additive;
the weight of the teraklylbenzene is 5 wt % to 40 wt % of the weight of the additive; and
the weight of the at least one of di-cycladipate or its homolog is 7 wt % to 30 wt % of the weight of the additive.

6. The electrolyte of claim 1 wherein
the at least one of halogeno-benzene or its homolog comprises at least one chemical selected from the group consisting of fluorobenzene, chlorobenzene, bromobenzene, and halogenating alkyl benzene.

7. The electrolyte of claim 1 wherein
the S═O bond compound comprises at least one chemical selected from the group consisting of ethylene sulfite, propylene sulfite, 1,3-propane sultone, dimethyl sulfite, diethyl sulfite, and dimethyl sulfoxide.

8. The electrolyte of claim 1 wherein
the at least one of biphenyl or its homolog comprises at least one chemical selected from the group consisting of biphenyl, 3-cyclohexyl biphenyl, trebiphenyl, and 1,3-biphenyl cyclohexane.

9. The electrolyte of claim 1 wherein
the at least one of phenylcyclohexane or its homolog comprises at least one chemical selected from the group consisting of 1,3-cyclohexylbenzene and phenylcyclohexane.

10. The electrolyte of claim 1 wherein
the teraklylbenzene comprises at least one chemical selected from the group consisting of tert-butyl benzene, tert-amylbenzene, and tert-hexyl benzene.

11. The electrolyte of claim 1 wherein
the at least one of di-cycladipate or its homolog comprises at least one chemical selected from the group consisting of succinic anhydride, dimethyl adipate, and hexane dioic anhydride.

12. A method for fabricating an electrolyte, comprising the steps of:
mixing a lithium salt, an organic solvent and an additive together wherein the additive comprises:
at least one of halogeno-benzene or its homolog;
S═O bond compound;
at least one of biphenyl or its homolog;
at least one of phenylcyclohexane or its homolog;
teraklylbenzene; and
at least one of di-cycladipate or its homolog.

13. The method for fabricating the electrolyte of claim 12 wherein the lithium salt is added only after the additive and the organic solvent are mixed thoroughly.

14. The method for fabricating the electrolyte of claim 13 wherein the mixture is heated under vacuum condition at a temperature between 45° C. to 70° C. for 10 to 20 minutes.

15. The method for fabricating the electrolyte of claim 12 wherein the concentration of the additive in the electrolyte is 2 wt % to 25 wt %.

16. A lithium ion battery comprising:
an electrode group wherein the electrode group comprises a positive electrode, a negative electrode and a separation membrane between the positive electrode and negative electrode; and
an electrolyte, wherein the electrolyte comprises the electrolyte, of claim 1.

17. A method for fabricating a lithium ion battery the method comprising the steps of:
fabricating a positive electrode of the lithium ion battery;
fabricating a negative electrode of the lithium ion battery;
placing a separation membrane between the positive electrode and the negative electrode to form an electrode group;
placing the electrode group in a battery shell;
injecting the electrolyte of claim 1 into the battery shell and
sealing the battery shell.
